(19) United States
(12) Patent Application Publication
(10) Pub. No.: US 2018/0159725 A1
(43) Pub. Date: Jun. 7, 2018

(54) REALLOCATION OF CONTROL OF ONLINE MANAGED SERVICES

(71) Applicant: NOKIA SOLUTIONS AND NETWORKS OY, Espoo (FI)

(72) Inventor: Gerald GOERMER, Wandlitz (DE)

(21) Appl. No.: 15/548,626

(22) PCT Filed: Feb. 3, 2015
(86) PCT No.: PCT/EP2015/052169

§ 371 Date: Aug. 3, 2017

(51) Int. Cl. H04L 12/24; H04W 72/08

(52) U.S. Cl. CPC H04L 41/0695; H04W 76/15; H04W 72/08

(57) ABSTRACT

It is provided a method, comprising instructing a control unit to control at least one of a controlled session and a controlled bearer based on a first control session; monitoring if, in response to a request to update the first control session, a reallocation failure message is received; checking, if the reallocation failure message is received, if a second control session different from the first control session is created; instructing the control unit to control the respective one of the controlled session and the controlled bearer based on the second control session if the second control session is created.

### FIELD OF THE INVENTION

The present invention relates to an apparatus, a method, and a computer program product related to mobile communication. More particularly, the present invention relates to an apparatus, a method, and a computer program product related to access to LTE based networks and/or IMS architecture.

### BACKGROUND OF THE INVENTION

### Abbreviations

### 3GPP 3rd Generation Partnership Project

### ABC Application Based Charging

### ABNF Augmented Backus-Naur Form

### AS Application Server

### AVP Attribute Value Pair

### CCA Credit-Control Answer

### CCR Credit-Control Request

### CN Core Network

### CSCF Call Session Control Function

### DB Data Base

### DCCA Diameter Credit-Control Application

### EDGE Enhanced Datarate for GSM Evolution

### EPC Evolved Packet Core

### GGSN Gateway GPRS Support Node

### GPRS Generic Packet Radio Service

### GSM Global System for Mobile Communication

Gx reference point between PCEF and PCRF
Gy reference point between PCEF and OCS

### Id Identifier

### IETF Internet Engineering Task Force

### IMS IP Multimedia Subsystem

### IMS-GWF IMS Gateway Function

### IP Internet Protocol

### IP-CAN IP Connectivity Access Network

### LTE Long Term Evolution

### LTE-A LTE Advanced

### MRFC Multimedia Resource Function Controller

### NG Network Gateway

### OCS Online Charging System

### PCC Policy and Charging Control

### PCS Policy Control Server

### P-CSCF Proxy CSCF

### PCEF Policy and Charging Enforcement Function

### PCRF Policy and Charging Resource Function

### PGW PDN Gateway

### PLMN Public Land Mobile Network

### PS Packet Switched

### PSTN Public Switched Telephone Network

### RAN Radio Access Network

### RC Result Code

### RCS Rich Communication Suite

### RFC Request for Comments

Ro reference point between IMS node and OCS

### S-CSCF Serving CSCF

### SIP Session Initiation Protocol

### SIP-AS SIP Application Server

### TDF Traffic Detection Function

### TS Technical Specification

### UE User Equipment

### UMTS Universal Mobile Telecommunications System

### UTRAN UMTS Terrestrial Radio Access Network

VoLTE Voice over LTE

### WiFi Wireless Fidelity

### WLAN Wireless Local Area Network

3GPP LTE based networks include the Evolved Packet Core (EPC) architecture and the IMS architecture and in particular the communication between the Packet Core (PS) network elements Gateway GPRS Support Node (GGSN)/PDN Gateway (PGW)/Traffic Detection Function (TDF) as well as the Serving Controlling Signalling Control Function (S-CSCF) with the Online Charging System (OCS) for online supervised services, e.g. VoLTE and RCS services.

The Online Charging communication is defined as Debit/Reserve Units operation and based on IETF Diameter application protocols which are specified in 3GPP EPC for Gy reference point and in 3GPP IMS for the Ro reference point. The use and triggering description is specified in 3GPP TS 32.251 for packet core charging procedures of IP-CAN session/bearer and of TDF session as specified for Gyn reference point. 3GPP TS 32.260 contains the description for IMS controlled services. The interface for the mentioned Gy and Ro reference points are specified in the document 3GPP TS 32.299 as Debit/Reserve Units operation for the online charging protocol details, the Ro interface protocol.

The Traffic Detection Function (TDF) supports Application Based Charging (ABC) functionality according to 3GPP TS 23.203 and defined in 3GPP TS 32.251.

The Policy Control and Charging operations of the 3GPP specifications are based on the mapping and extension of the IETF RFCs 3588 Diameter Base protocol and IETF RFC 4006 Diameter Credit-Control Application (DCCA).

The DCCA specifies the session charging approach. Some basic methods are Credit-Control Request (CCR) and the corresponding Credit-Control Answer (CCA), either with initial, intermediate, or terminate indication. The Diameter clients (e.g. one or more of GGSN, PGW, PCEF, TDF, S-CSCF, and IMS-GWF) act with the corresponding Debit/Reserve Units Request for CCR and the OCS (Diameter Server) answers with Debit/Reserve Units Response for CCA. Diameter is formally specified in ABNF syntax. Parameters of the methods are called Attribute Value Pairs (AVP). The CCA contains normally a Result-Code AVP of type unsigned32, indicating the status of the request processing with the following classes:
1xxx (Informational)
2xxx (Success)
3xxx (Protocol Errors)
4xxx (Transient Failures)
5xxx (Permanent Failure)

The IETF RFC 3588 describes the alternative use of a vendor specific result definition, i.e. Experimental Result instead of Result-Code AVP:

```
Experimental-Result ::= < AVP Header: 297 >
          { Vendor-Id }
          { Experimental-Result-Code }
```

The Experimental-Result-Code AVP should follow the classification as defined for the Result-Code AVP. The use of the Experimental-Result AVP has not yet been specified for 3GPP Debit/Reserve Units operation, refer to 3GPP TS 32.299.

In the EPC network, a Diameter session most commonly corresponds to an IP-CAN session/bearer, i.e. supervises the traffic data passed through that session/bearer. This is done by granting quota (OCS) and depletion of quota (GGSN/PGW/PCEF/TDF) sent over Gy for the IP-CAN session/bearer or over Gyn for the TDF session. For IMS based services imbedded in the EPC network, e.g. VoLTE or RCS services, the control is performed with a Diameter session over Ro interface for each IMS session at the S-CSCF (IMS-GWF).

### SUMMARY OF THE INVENTION

It is an object of the present invention to improve the prior art.

According to a first aspect of the invention, there is provided an apparatus, comprising instructing means adapted to instruct a control unit to control at least one of a controlled session and a controlled bearer based on a first control session; monitoring means adapted to monitor if, in response to a request to update the first control session, a reallocation failure message is received; checking means adapted to check, if the reallocation failure message is received, if a second control session different from the first control session is created; wherein the instructing means is further adapted to instruct the control unit to control the respective one of the controlled session and the controlled bearer based on the second control session if the second control session is created.

The apparatus may further comprise controlled session terminating means adapted to terminate the controlled session and to dismantle the controlled bearer, respectively, if any of plural failure messages is received in response to the request for update of the first control session, wherein the reallocation failure message is one of the plural failure messages; inhibiting means adapted to inhibit the controlled session terminating means from terminating the controlled session and dismantling the controlled bearer, respectively, if the reallocation failure message is received.

The apparatus may further comprise at least one of control session terminating means adapted to terminate the first control session if the reallocation failure message is received; and creating means adapted to create the second control session if the reallocation failure message is received.

The apparatus comprising the creating means may further comprise checking means adapted to check if the first control session is terminated; prohibiting means adapted to prohibit that the creating means creates the second control session if the first control session is not terminated.

Each of the first control session and the second control session may provide quota for the controlled session and the controlled bearer, respectively, and the apparatus may further comprise accumulating means adapted to accumulate quota used between the request to update the first control session and the creation of the second control session; and at least one of deducting means adapted to deduct the accumulated used quota from quota provided by the second control session; and informing means adapt to inform a control device on the accumulated used quota via the second control session.

According to a second aspect of the invention, there is provided an apparatus, comprising monitoring means adapted to monitor if a predefined failure occurs; responding means adapted to respond, if the predefined failure occurs, by a reallocation failure message in response to an update request to update a first control session, wherein the first control session is adapted to control at least one of a controlled session and a controlled bearer; checking means adapted to check if a second control session different from the first control session is created, wherein the second control session is adapted to control the controlled session and the controlled bearer, respectively; providing means adapted to provide, if the second control session is created, a control message for the controlled session and the controlled bearer, respectively, via the second control session.

The apparatus may further comprise creating means adapted to create the second control session in response to the received request to initiate the second control session; termination monitoring means adapted to monitor if the first control session is terminated; inhibiting means adapted to inhibit the creating means from creating the second control session if the first control session is not terminated.

The predefined failure may be one of an installation of a new software on the apparatus and an unavailability of a user database, wherein the control message is generated based on data of the user database.

The request to initiate the second control session may comprise an identifier of the controlled session and the controlled bearer, respectively.

Each of the first control session and the second control session may be adapted to provide quota for the controlled session and the controlled bearer, respectively; and the apparatus may further comprise deducting means adapted to deduct accumulated used quota from quota stored for the controlled session and the controlled bearer, respectively, wherein information on the accumulated used quota is received via the second control session.

According to a third aspect of the invention, there is provided an apparatus, comprising instructing circuitry configured to instruct a control unit to control at least one of a controlled session and a controlled bearer based on a first control session; monitoring circuitry configured to monitor if, in response to a request to update the first control session, a reallocation failure message is received; checking circuitry configured to check, if the reallocation failure message is received, if a second control session different from the first control session is created; wherein the instructing circuitry is further configured to instruct the control unit to control the respective one of the controlled session and the controlled bearer based on the second control session if the second control session is created.

The apparatus may further comprise controlled session terminating circuitry configured to terminate the controlled session and to dismantle the controlled bearer, respectively, if any of plural failure messages is received in response to the request for update of the first control session, wherein the reallocation failure message is one of the plural failure messages; inhibiting circuitry configured to inhibit the controlled session terminating circuitry from terminating the controlled session and dismantling the controlled bearer, respectively, if the reallocation failure message is received.

The apparatus may further comprise at least one of control session terminating circuitry configured to terminate the first control session if the reallocation failure message is received; and creating circuitry configured to create the second control session if the reallocation failure message is received.

The apparatus comprising the creating circuitry may further comprise checking circuitry configured to check if the first control session is terminated; prohibiting circuitry configured to prohibit that the creating circuitry creates the second control session if the first control session is not terminated.

Each of the first control session and the second control session may provide quota for the controlled session and the controlled bearer, respectively, and the apparatus may further comprise accumulating circuitry configured to accumulate quota used between the request to update the first control session and the creation of the second control session; and at least one of deducting circuitry configured to deduct the accumulated used quota from quota provided by the second control session; and informing circuitry adapt to inform a control device on the accumulated used quota via the second control session.

According to a fourth aspect of the invention, there is provided an apparatus, comprising monitoring circuitry configured to monitor if a predefined failure occurs; responding circuitry configured to respond, if the predefined failure occurs, by a reallocation failure message in response to an update request to update a first control session, wherein the first control session is configured to control at least one of a controlled session and a controlled bearer; checking circuitry configured to check if a second control session different from the first control session is created, wherein the second control session is configured to control the controlled session and the controlled bearer, respectively; providing circuitry configured to provide, if the second control session is created, a control message for the controlled session and the controlled bearer, respectively, via the second control session.

The apparatus may further comprise creating circuitry configured to create the second control session in response to the received request to initiate the second control session; termination monitoring circuitry configured to monitor if the first control session is terminated; inhibiting circuitry configured to inhibit the creating circuitry from creating the second control session if the first control session is not terminated.

The predefined failure may be one of an installation of a new software on the apparatus and an unavailability of a user database, wherein the control message is generated based on data of the user database.

The request to initiate the second control session may comprise an identifier of the controlled session and the controlled bearer, respectively.

Each of the first control session and the second control session may be configured to provide quota for the controlled session and the controlled bearer, respectively; and the apparatus may further comprise deducting circuitry configured to deduct accumulated used quota from quota stored for the controlled session and the controlled bearer, respectively, wherein information on the accumulated used quota is received via the second control session.

According to a fifth aspect of the invention, there is provided a method, comprising instructing a control unit to control at least one of a controlled session and a controlled bearer based on a first control session; monitoring if, in response to a request to update the first control session, a reallocation failure message is received; checking, if the reallocation failure message is received, if a second control session different from the first control session is created; instructing the control unit to control the respective one of the controlled session and the controlled bearer based on the second control session if the second control session is created.

The method may further comprise terminating the controlled session and dismantling the controlled bearer, respectively, if any of plural failure messages is received in response to the request for update of the first control session, wherein the reallocation failure message is one of the plural failure messages; inhibiting the terminating of the controlled session and dismantling the controlled bearer, respectively, if the reallocation failure message is received.

The method may further comprise at least one of terminating the first control session if the reallocation failure message is received; and creating the second control session if the reallocation failure message is received.

The method comprising the creating of the second control session may further comprise checking if the first control session is terminated; prohibiting the creating of the second control session if the first control session is not terminated.

Each of the first control session and the second control session may provide quota for the controlled session and the controlled bearer, respectively, and the method may further comprise accumulating quota used between the request to update the first control session and the creation of the second control session; and at least one of deducting the accumulated used quota from quota provided by the second control session; and informing a control device on the accumulated used quota via the second control session.

According to a sixth aspect of the invention, there is provided a method, comprising monitoring if a predefined failure occurs; responding, if the predefined failure occurs, by a reallocation failure message in response to an update request to update a first control session, wherein the first control session is adapted to control at least one of a controlled session and a controlled bearer; checking if a second control session different from the first control session is created, wherein the second control session is adapted to control the controlled session and the controlled bearer, respectively; providing, if the second control session is created, a control message for the controlled session and the controlled bearer, respectively, via the second control session.

The method may further comprise creating the second control session in response to the received request to initiate the second control session; monitoring if the first control session is terminated; inhibiting the creating of the second control session if the first control session is not terminated.

The predefined failure may be one of an installation of a new software on an apparatus performing the method and an unavailability of a user database, wherein the control message is generated based on data of the user database.

The request to initiate the second control session may comprise an identifier of the controlled session and the controlled bearer, respectively.

Each of the first control session and the second control session may be adapted to provide quota for the controlled session and the controlled bearer, respectively; and the method may further comprise deducting accumulated used quota from quota stored for the controlled session and the controlled bearer, respectively, wherein information on the accumulated used quota is received via the second control session.

The method according to each of the fifth and sixth aspects may be a method of control of an online managed service.

According to each of the first to sixth aspects, at least one of the first control session and the second control session may be a diameter session.

According to each of the first to sixth aspects, the controlled session and the controlled bearer, respectively, may provide an online charged service, and the online charging may be controlled by each of the first control session and the second control session.

According to each of the first to sixth aspects, the controlled session may be a connectivity access network session, and the controlled bearer may be a connectivity access network bearer, respectively.

According to a seventh aspect of the invention, there is provided a computer program product comprising a set of instructions which, when executed on an apparatus, is configured to cause the apparatus to carry out the method according to any of the fifth and sixth aspects. The computer program product may be embodied as a computer-readable medium or directly loadable into a computer.

According to some embodiments of the invention, at least the following advantages are provided:
Signalling overhead for the release and potentially re-establishment of core network resources, e.g. IP-CAN session, Air interface, IMS session is prevented;
Smooth user experience: The technical issues in the architecture are hidden from the customer, i.e. no annoying disconnect—reconnect (IP-CAN session/bearer, VoLTE, IMS session for RCS, TDF session) will have to happen;
Modification of processing for existing result codes is not needed.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a message flow according to an embodiment of the invention;

FIG. 2 shows a message flow according to an embodiment of the invention;

FIG. 3 shows a message flow according to an embodiment of the invention;

FIG. 4 shows a message flow according to an embodiment of the invention;

FIG. 5 shows an apparatus according to an embodiment of the invention;

FIG. 6 shows a method according to an embodiment of the invention;

FIG. 7 shows an apparatus according to an embodiment of the invention;

FIG. 8 shows a method according to an embodiment of the invention; and

FIG. 9 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

3GPP TS 32.299 specification poorly concretizes the Result-Code AVP processing, i.e. what action is to be done on online charging application client side when a specific negative value is received.

Typically, if a negative result code leads to an abnormal termination of the Diameter session, then the corresponding IP-CAN session/IMS session is also terminated. For EPC refer to 3GPP TS 23.401—PGW initiated bearer deactivation and Detach procedure descriptions—as well as to 3GPP TS 23.203 IP-CAN session and TDF session modification and termination procedures. For IMS domain refer to 3GPP TS 23.228 network initiated session release procedures.

There are some subtleties depending on specific code values, vendor specific interpretations and failure handling configuration, but terminating the IP-CAN session/IMS session is the most common scenario if the Diameter session is terminated. In any case, if the Diameter session is closed due to a failure resulting in a negative result code it will not open again, even when the IP-CAN session/bearer is continued for some reason.

Termination of an IP-CAN session/bearer causes huge amount of signalling traffic that finally may lead to the release of the air interface to the user's equipment (UE, e.g. a smart phone). Also, if the user sets up another IP-CAN session/IMS session with a correlated Diameter session, again a huge amount of signalling traffic is required.

Some embodiments of the invention aim at preventing such termination as far as possible because, in the packet core domain, in particular in LTE networks, some operators are already struggling with high signalling and data traffic load.

According to some embodiments of the invention, a procedure is established that allows the “reallocation” of the IP-CAN session, TDF session, and/or IMS session to another control session. Reallocation in this way means that the controlling Diameter session shall be terminated and a subsequent Diameter session shall be immediately opened—without any effect on the controlled resource, e.g. the IP-CAN session/bearer traffic and/or TDF session traffic and/or IMS session traffic.

Some example scenarios where such procedure is particularly useful are:
Recovery scenario: A component of the PCS/OCS architecture may fail, e.g. the customer data base. In that case, a rescue service may take over the task of the normal Diameter service (real-time charging). The rescue service handles the Diameter session in a very basic way because the specific customer data are not available. I.e., the Diameter session is continued with further data recording as received from the interface client and plain quota granting (to keep it alive). If, after a while, the customer DB is available again and the normal Diameter service could take over, it is technically not feasible to apply real-time charging in mid-session again. So, according to the current specification, the OCS terminates the Diameter session, e.g. by a 5xxx class negative Result-Code AVP. As a side effect, the complete IP-CAN session/bearer and radio connection are torn down (PS domain) and the VoLTE and/or RCS services (IMS domain) are discontinued, respectively.
Robustness/error scenario: A new PCS/OCS software version may be installed in life operation which does not allow to continue the session (may or may not be caused by bugs)—but would work fine if initially (by CCR initial) triggered. Again, according to the current specification the OCS would terminate the Diameter session, e.g. by a 5xxx class negative Result-Code AVP. As a side effect, the complete IP-CAN session/bearer and radio connection are torn down (PS domain) and the VoLTE and/or RCS services (IMS domain) are discontinued, respectively.

These problems have not been solved. As explained beforehand, for the relevant scenarios a complete packet core session/bearer tear down is initiated (PS domain), and the VoLTE or RCS services (IMS domain) is discontinued, respectively. This causes a lot of signalling overhead. It also demolishes the customer experience as he is required to connect to the packet core again and has to set-up a new VoLTE or RCS service, respectively.

Some embodiments of this invention cover a generic solution to these problems by “reallocation” of Diameter sessions to the controlled (underlying) resource without a direct effect on the controlled resources (e.g. IP-CAN session/bearer, IMS session). It is realized by introducing a new functionality for a case that a specific result code in the Diameter answer message is sent from the server. Namely, the client is hereupon compelled to terminate the concerned Diameter session and to immediately open a “follow-up” Diameter session.

According to some embodiments of the invention, a new Diameter result code value and its associated processing are specified.

According to some example embodiments of the invention, the result code is defined as transient failure class value (4xxx), e.g. “4161—DIAMETER_REALLOCATE_SESSION”. That value may be set up in the Experimental-Result-Code AVP. Alternatively, or in addition, the Result-Code AVP could be populated with that value. In the latter case, normally assignment by IETF (by set-up of an RFC and its approval) is required.

As shown in Table 1, the Experimental-Result-Code AVP value, if specified by 3GPP, may be defined in e.g. 3GPP TS 29.230, in particular in its section related to 3GPP TS 32.299.

TABLE 1
3GPP specific Transient Failure result codes
(based on 3GPP TS 29.230, Table 8.1.3)

| Experi- | | |
|---|---|---|
| mental | | Specified |
| Result | | in 3GPP |
| Code | Result text | TS |
| 4100 | DIAMETER_USER_DATA_NOT_AVAILABLE | 29.329 |
| 4101 | DIAMETER_PRIOR_UPDATE_IN_PROGRESS | |

Note: The Experimental Result Codes from 4102 to 4120 are reserved for
the TS 29.329.

| | | |
|---|---|---|
| 4121 | DIAMETER_ERROR_OUT_OF_RESOURCES | 29.061 |

Note: The Experimental Result Codes from 4122 to 4140 are reserved for
the TS 29.061.

| | | |
|---|---|---|
| 4141 | DIAMETER_PCC_BEARER_EVENT | 29.212 |
| 4142 | DIAMETER_BEARER_EVENT | |
| 4143 | DIAMETER_AN_GW_FAILED | |

Note: The Experimental Result Codes from 4144 to 4160 are reserved for
the TS 29.212

| | | |
|---|---|---|
| 4161 | DIAMETER_REALLOCATE_SESSION | 32.299 |

Note: The Experimental Result Codes from 4162 to 4180 are reserved for
the TS 32.299.

Table 1 shows one example assignment. Instead of the experimental result code 4161, another value may be assigned to reallocation. Also, the result text is an example and may be different from that shown in Table 1.

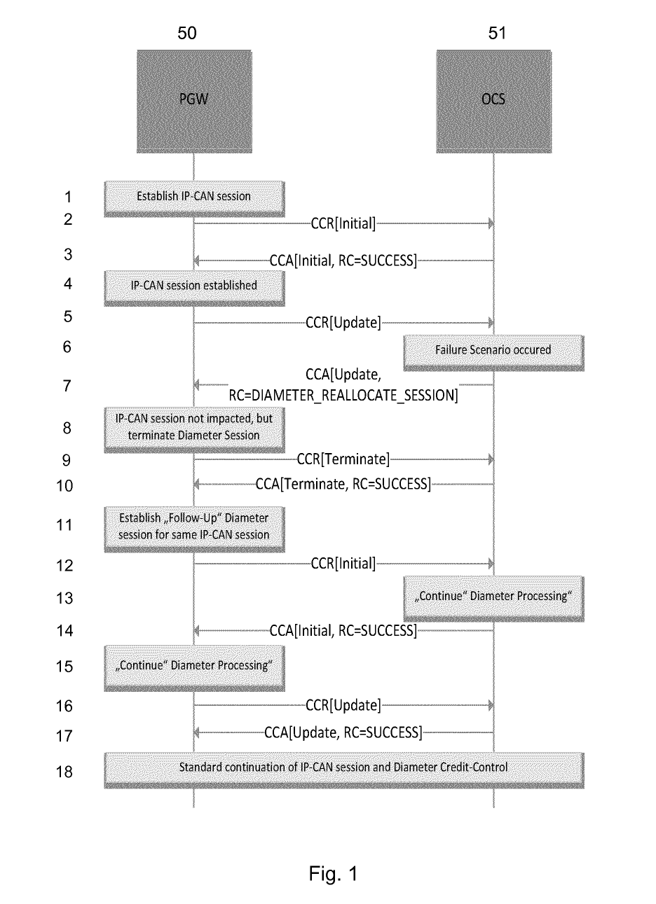

FIG. 1 shows a flow for EPC networks according to some embodiments of the invention. The flow is between a PGW 50 and an OCS 51. Note that FIGS. 1 to 4 do not show all messages exchanged and actions performed by the respective network elements but show only messages which are considered to be useful for the understanding of the invention.

In 1, the PGW 50 starts to establish an IP-CAN session. Since the IP-CAN session (or a service transported in the IP-CAN session) needs online charging, in 2, PGW 50 sends CCR[Initial], thus requesting initial quota (credit). The request of 2 comprises, as a control identifier, an identification of the IP-CAN session (e.g. its session number). In 3, OCS 51 answers by CCA[Initial, RC=success], thus informing PGW 50 on initial quota. In 4, the IP-CAN session is established.

Then, in 5, PGW 50 sends CCR[Update]. This request may be sent on regular basis, when the quota is exhausted, or at other occasions. As shown in 6, one of the predefined failure scenarios (such as unavailability of a user database and/or installation of new software on OCS 51) occurs at OCS 51. Accordingly, CCR[Update] of 5 is not successful and, in 7, OCS 51 provides CCA[Update, RC=Diameter_Reallocate_Session] to PGW 50. I.e., OCS 51 indicates that the IP-CAN session should be reallocated to control by another Diameter session to be established between PGW 50 and OCS 51.

When PGW 50 receives CCA[Update, RC=Diameter_Reallocate_Session] in 7, it does not impact the IP-CAN session (8) but terminates the Diameter session with OCS 51 (9), which is acknowledged by OCS 51 in 10.

After the Diameter session is terminated, PGW 50 establishes in 11 a new (“follow up”) diameter session for the same IP-CAN session. In detail, in 12, PGW 50 sends CCR[Initial] to OCS 51, wherein the request comprises, as a control identifier, the same session identifier (e.g. session number) of the IP-CAN session as the request in 2.

In 13, OCS 51 recognizes, due to the control identifier (i.e. the IP-CAN session), that CCR[Initial] of 12 is in fact a request to set up a new session in order to continue diameter procession of the session established in 1 to 4. Accordingly, in 14, OCS 51 acknowledges session establishment by CCA[Initial, RC=success]. In addition, OCS 51 may provide new quota for the IP-CAN session to PGW 50 with CCA[Initial, RC=success] of 14. In 15, PGW 50 knows that the new session is for continuing diameter processing because the new session was established in view of the received RC=Diameter_Reallocate_Session in 7. Provided new quota may be handled as quota update.

16 to 18 are shown for illustration only and show conventional behavior if a failure does not occur. Namely, in 16, PGW 50 request CCR[Update] as in 5. This time, there is no failure at OCS 51. Accordingly, in 17, OCS 51 replies with CCA[Update, RC=success], eventually providing also new quota. The conventional behavior may be continued (18).

In some embodiments of the invention, some delta measurement is implemented. For example, the “follow-up” session gets from PGW 50 accumulated quota used between CCR[Update] (5) and CCA[Initial, RC=success] (14) and OCS subtracts this accumulated quota if new quota will be granted. As another example, PGW may deduct the accumulated used quota from the quota provided by CCA[Initial, RC=success] (14).

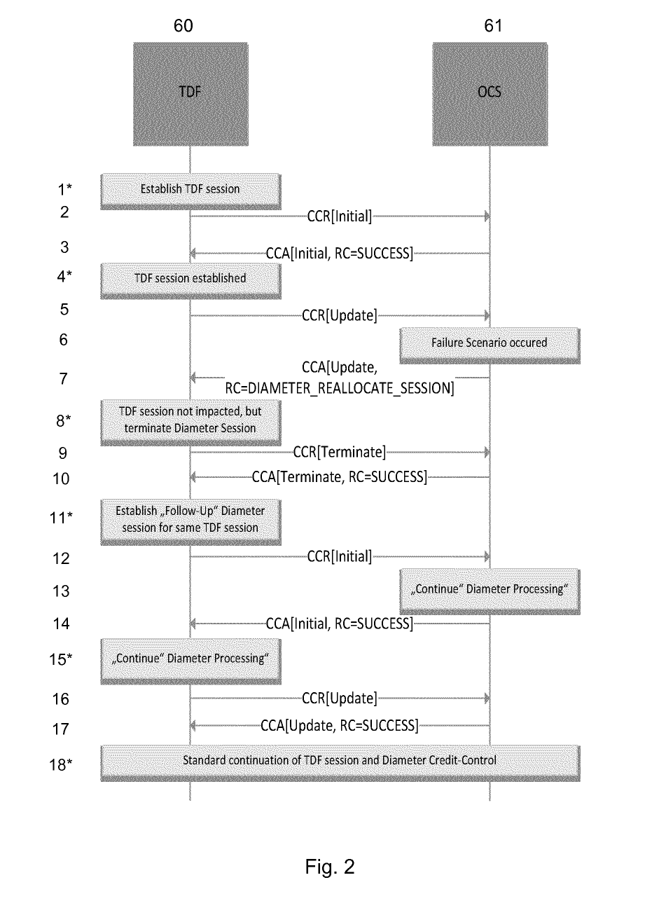

FIG. 2 corresponds to FIG. 1, wherein the PS based service is replaced by a TDF session, PGW 50 is correspondingly replaced by TDF 60, and OCS 51 is correspondingly replaced by OCS 61. Messages and actions with the same numbers as according to FIG. 1 are the same as in FIG. 1. Actions 1, 4, 8, 11, 15, and 18 of FIG. 1 are replaced by actions 1*, 4*, 8*, 11*, 15* and 18*, respectively. These actions correspond to each other, wherein “IP-CAN session” of FIG. 1 is replaced by “TDF session” of FIG. 2. A detailed description thereof is accordingly not repeated but it is referred to the description of FIG. 1.

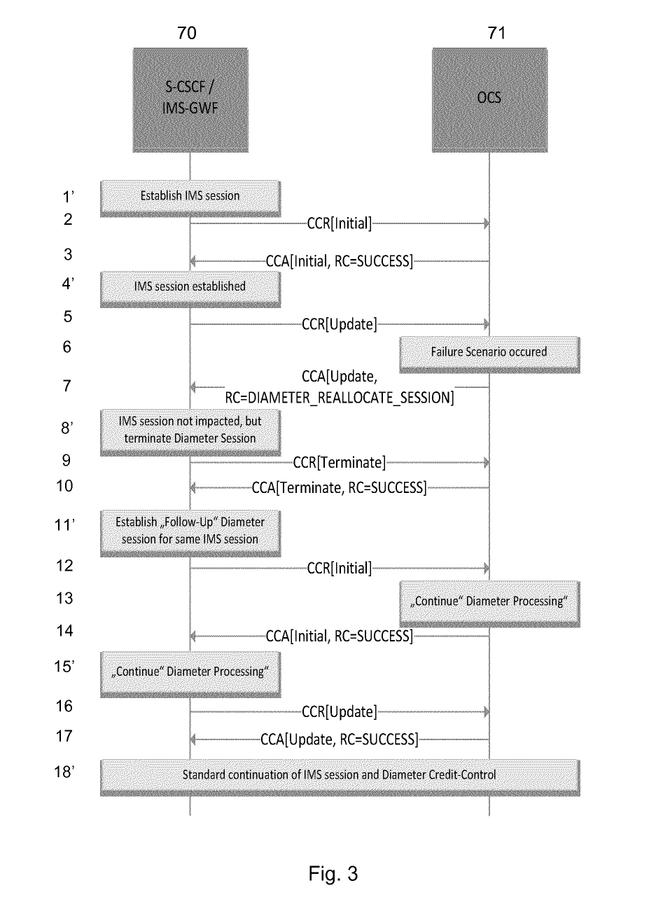

FIG. 3 corresponds to FIG. 1 (or FIG. 2), wherein the PS based service is replaced by an IMS controlled service and PGW 50 is correspondingly replaced by S-CSCF 70 or IMS-GWF 70. OCS 71 may be the same as OCS 51 of FIG. 1 or different thereof. Messages and actions with the same numbers as according to FIG. 1 are the same as in FIG. 1. Actions 1, 4, 8, 11, 15, and 18 of FIG. 1 are replaced by actions 1′, 4′, 8′, 11′, 15′ and 18′, respectively. These actions correspond to each other, wherein “IP-CAN session” of FIG. 1 is replaced by “IMS session” of FIG. 3. A detailed description thereof is accordingly not repeated but it is referred to the description of FIG. 1.

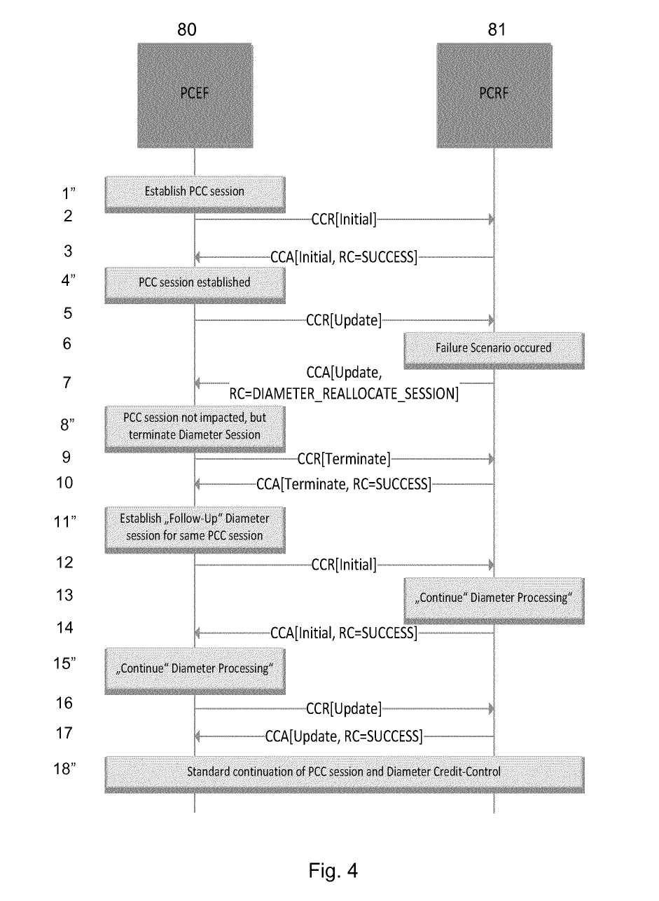

FIG. 4 corresponds to FIG. 1 (or FIG. 2 or FIG. 3), wherein the PS based service is replaced by a PCC session, PGW 50 is correspondingly replaced by PCEF 80, and OCS 51 is correspondingly replaced by PCRF 81. Messages and actions with the same numbers as according to FIG. 1 are the same as in FIG. 1. Actions 1, 4, 8, 11, 15, and 18 of FIG. 1 are replaced by actions 1″, 4″, 8″, 11″, 15″ and 18″, respectively. These actions correspond to each other, wherein “IP-CAN session” of FIG. 1 is replaced by “PCC session” of FIG. 4. A detailed description thereof is accordingly not repeated but it is referred to the description of FIG. 1.

In FIGS. 1 to 4, establishing the second Diameter session is started by PGW/TDF/S-CSCF/IMS-GWF/PCEF (12) after it received the information that the first part of the Diameter session is terminated. According to some embodiments of the invention, PGW/TDF/S-CSCF/IMS-GWF/PCEF may not wait for the information on termination but establish the second Diameter session (12) immediately (or a predefined time) after it requests the termination of the first Diameter session (9).

According to some embodiments of the invention, the establishing of one or both of the first and second Diameter sessions (2, 12) is not started by PGW/TDF/S-CSCF/IMS-GWF/PCEF as in FIGS. 1 to 4, but by OCS/PCRF.

In some embodiments of the invention, the message CCA[Update, RC=Diameter_Reallocate_Session] may implicitly include a termination request, or OCS/PCRF may request a termination request in addition to CCA[Update, RC=Diameter_Reallocate_Session]. Thus, PGW/TDF/S-CSCF/IMS-GWF/PCEF do not request termination in 9, but acknowledge termination instead. Thus, in the former case, the number of exchanged messages is reduced by 1.

In some embodiments of the invention, the first Diameter session may not be terminated but left open (e.g. for some period of time or until a certain event) and not used any more for control of the IP-CAN/IMS/PCC session.

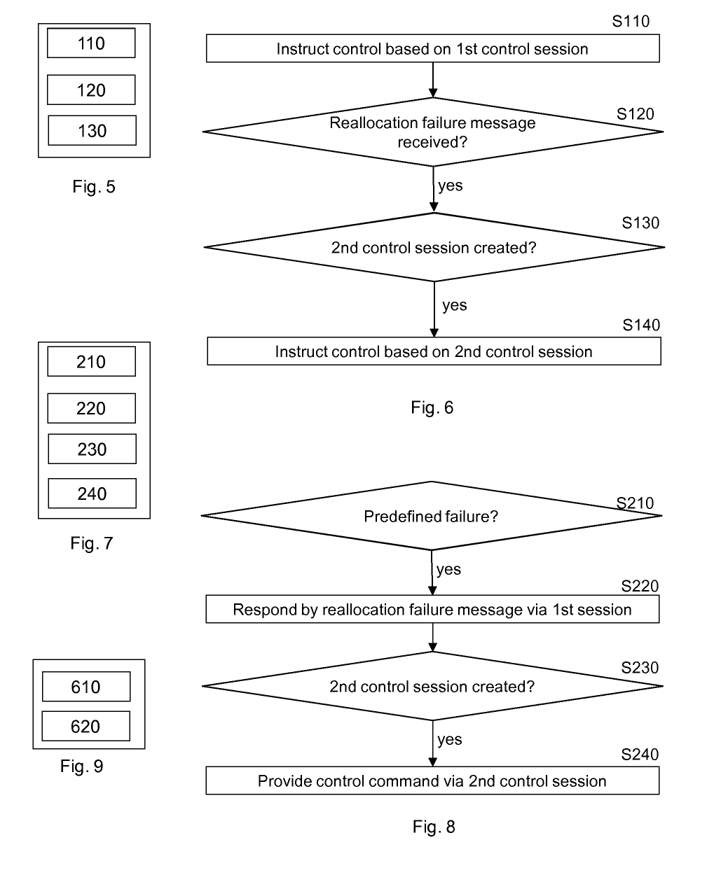

FIG. 5 shows an apparatus according to an embodiment of the invention. The apparatus may be a server transporting a user traffic session such as a PGW and/or TDF and/or PCEF and/or S-CSCF and/or IMS-GWF or an element thereof. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises instructing means 110, monitoring means 120, and checking means 130.

The instructing means 110 instructs a control unit to control a controlled session based on a first control session. The controlled session may be a session carrying user traffic such as an IP-CAN session or an IMS session. It may be a PCC session. The first control session may be a Diameter session.

The monitoring means 120 monitors if, in response to a request to update the first control session, a reallocation failure message is received (S120).

If the reallocation failure message is received (“yes” in S120), the checking means 130 checks if a second control session different from the first control session is created (S130). Note that the creation of the 2^{nd} control session may be initiated by the apparatus or by a control device (such as an OCS or PCRF) sharing each of the first and second control sessions with the apparatus.

If the second control session is created (“yes” in S130), the instructing means 110 instructs the control unit to control the controlled session based on the second control session (S140). In some embodiments of the invention, control commands for the controlled session received via the first control session are then ignored.

FIG. 7 shows an apparatus according to an embodiment of the invention. The apparatus may be a control apparatus such as an OCS and/or a PCRF or an element thereof. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises monitoring means 210, creating means 220, and providing means 230.

The monitoring means 210 monitors if a predefined failure occurs (S210). E.g., a predefined failure may be one of an installation of a new software on the apparatus and an unavailability of a user database on which control via the first control session is based.

If the predefined failure occurs (“yes” in S210), the responding means 220 responds to an update request by a reallocation failure message (S220). The update request requests to update a first control session. The first control session is adapted to control a controlled session.

The checking means 230 checks if a second control session different from the first control session is created (S230). The second control session is adapted to control the controlled session, too. The checking means 230 may check only for the creation of the second control session if the reallocation failure message was provided by the responding means 220.

If the second control session is created (“yes” in S230), the providing means 240 provides a control message for the controlled session via the second control session. Furthermore, in some embodiments of the invention, providing control messages for the controlled session via the first control session may then be inhibited.

According to some embodiments of the invention, in FIGS. 5 to 8, the controlled session may be replaced by a controlled bearer, or by a combination of a controlled bearer and the controlled session.

FIG. 9 shows an apparatus according to an embodiment of the invention. The apparatus comprises at least one processor 610, at least one memory 620 including computer program code, and the at least one processor 610, with the at least one memory 620 and the computer program code, being arranged to cause the apparatus to at least perform at least one of the methods according to FIGS. 6 and 8 and related description.

Some embodiments of the invention may be employed to one, some, or all of Gy, Gyn and Ro reference points.

Some embodiments of the invention may be employed to the Policy and Charging Control Interfaces between Policy and Charging Rule Function (PCRF) and e.g. the PGW (comprising PCEF), on reference point Gx. Thus, the charging protocol framework may be extended to this domain. I.e., OCS of FIGS. 1 to 3 may be replaced by a rules function such as PCRF. The new functionality may be standardized by amending 3GPP TS 29.212. In general, instead of or in addition to quota (OCS) and/or policies (PCRF), any control commands for controlling the controlled session (e.g. the IP-CAN session) may be provided via the control session.

In general, some embodiments of the invention may be controlled to any case where one session (such as the IP-CAN session of FIG. 1 or another PS session, also named “controlled session”, e.g. a user traffic session) is controlled by another session (also named “control session”) in case of certain failures of the control session. For example, some embodiments of the invention may be implemented into products acting as Policy Control Resource Function (PCRF) which interact with Flexi NG of Nokia Solutions and Networks.

According to some embodiment of the invention, an IMS node acting as a Diameter client may be also a Multimedia Resource Function Controller (MRFC) or a (dedicated) SIP Application Server (SIP-AS) according to 3GPP TS 32.260.

Some embodiments of the invention may be related to an IP-CAN session as a controlled session and/or to an IP-CAN bearer as a controlled bearer. That is, the method applied to a controlled session may be applied correspondingly to a controlled bearer. For example, instead of establishing and releasing a session, a bearer may be created and dismantled (also named “terminated”). Within the present description, these options are sometimes marked as “IP-CAN session/bearer”. However, unless explicitly explained or otherwise made clear from the context, each occurrence of “IP-CAN session” may be read as “IP-CAN session and/or IP-CAN bearer”, and each occurrence of “IP-CAN bearer” may be read as “IP-CAN session and/or IP-CAN bearer”.

According to some embodiments of the invention, the reallocation failure message may be transmitted by a dedicated message different from “normal” (conventional) failure messages. In this case, a RC AVP may not be necessarily defined.

Some embodiments of the invention are applied to interfaces where the Diameter protocol is used. However, in other embodiments of the invention, other protocols such as a Radius protocol may be employed instead.

Some embodiments of the invention may be employed in a 3GPP network such as an EPC network. They may be employed also in other 3GPP and non-3GPP mobile and fixed networks such as CDMA, EDGE, LTE, LTE-A, UTRAN, WiFi, WLAN networks, PSTN, etc.

A terminal may be a user equipment such as a mobile phone, a smart phone, a PDA, a laptop, a tablet PC, a wearable, a machine-to-machine device, or any other device which may be connected to the respective network such as a 3GPP network. If not otherwise indicated or made clear from the context, the terms “UE” and “user” are synonymously used in the present application.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

According to the above description, it should thus be apparent that example embodiments of the present invention provide, for example a gateway such as a PGW (or a TDF) or an S-CSCF, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example a call session control function such as a S-CSCF, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example an online charging system such as a OCS, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example an enforcement function such as a PCEF, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example a rules function such as a PCRF, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques, means, devices, or methods include, as non-limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. An apparatus, comprising;
at least one processor; and
at least one memory including computer program code;
the at least one memory and the computer program code configured to, with the at least one processor, cause the apparatus at least to perform
instructing a control unit to control at least one of a controlled session and a controlled bearer based on a first control session;
monitoring if, in response to a request to update the first control session, a reallocation failure message is received;
checking, if the reallocation failure message is received, if a second control session different from the first control session is created; wherein
instructing the control unit to control the respective one of the controlled session and the controlled bearer based on the second control session if the second control session is created.

2. The apparatus according to claim 1, further wherein the computer program code is further configured to cause the apparatus to perform:
terminating the controlled session and to dismantle the controlled bearer, respectively, if any of plural failure messages is received in response to the request for update of the first control session, wherein the reallocation failure message is one of the plural failure messages;
inhibiting the terminating of the controlled session and dismantling the controlled bearer, respectively, if the reallocation failure message is received.

3. The apparatus according to claim 1, wherein the computer program code is further configured to cause the apparatus to perform:
terminating the first control session if the reallocation failure message is received; and
creating the second control session if the reallocation failure message is received.

4. The apparatus according to claim 3, wherein the computer program code is further configured to cause the apparatus to perform:
checking if the first control session is terminated;
prohibiting the creating of the second control session if the first control session is not terminated.

5. The apparatus according to claim 1, wherein each of the first control session and the second control session provide quota for the controlled session and the controlled bearer, respectively, and wherein the computer program code is further configured to cause the apparatus to perform:
accumulating quota used between the request to update the first control session and the creation of the second control session; and at least one of
deducting the accumulated used quota from quota provided by the second control session; and
informing a control device on the accumulated used quota via the second control session.

6. An apparatus, comprising;
at least one processor; and
at least one memory including computer program code;
the at least one memory and the computer program code configured to, with the at least one processor, cause the apparatus at least to perform:
monitoring if a predefined failure occurs;
responding, if the predefined failure occurs, by a reallocation failure message in response to an update request to update a first control session, wherein the first control session is configured to control at least one of a controlled session and a controlled bearer;
checking if a second control session different from the first control session is created, wherein the second control session is configured to control the controlled session and the controlled bearer, respectively;
providing, if the second control session is created, a control message for the controlled session and the controlled bearer, respectively, via the second control session.

7. The apparatus according to claim 6, wherein the computer program code is further configured to cause the apparatus to perform:
creating the second control session in response to the received request to initiate the second control session;
monitoring if the first control session is terminated;
inhibiting the creating of the second control session if the first control session is not terminated.

8. (canceled)

9. (canceled)

10. The apparatus according to claim 6, wherein each of the first control session and the second control session is adapted to provide quota for the controlled session and the controlled bearer, respectively, and wherein the computer program code is further configured to cause the apparatus to perform:
deducting accumulated used quota from quota stored for the controlled session and the controlled bearer, respectively, wherein information on the accumulated used quota is received via the second control session.

11.-13. (canceled)

14. A method, comprising;
instructing a control unit to control at least one of a controlled session and a controlled bearer based on a first control session;
monitoring if, in response to a request to update the first control session, a reallocation failure message is received;
checking, if the reallocation failure message is received, if a second control session different from the first control session is created;
instructing the control unit to control the respective one of the controlled session and the controlled bearer based on the second control session if the second control session is created.

15. The method according to claim 14, further comprising:
terminating the controlled session and dismantling the controlled bearer, respectively, if any of plural failure messages is received in response to the request for update of the first control session, wherein the reallocation failure message is one of the plural failure messages;
inhibiting the terminating of the controlled session and dismantling the controlled bearer, respectively, if the reallocation failure message is received.

16. The method according to claim 14, further comprising at least one of
terminating the first control session if the reallocation failure message is received; and
creating the second control session if the reallocation failure message is received.

17. The method according to claim 16, comprising the creating of the second control session and further comprising:
checking if the first control session is terminated;
prohibiting the creating of the second control session if the first control session is not terminated.

18. The method according to claim 14, wherein each of the first control session and the second control session provide quota for the controlled session and the controlled bearer, respectively, and the method further comprises:
accumulating quota used between the request to update the first control session and the creation of the second control session; and at least one of
deducting the accumulated used quota from quota provided by the second control session; and
informing a control device on the accumulated used quota via the second control session.

19. A method, comprising;
monitoring if a predefined failure occurs;
responding, if the predefined failure occurs, by a reallocation failure message in response to an update request to update a first control session, wherein the first control session is configured to control at least one of a controlled session and a controlled bearer;
checking if a second control session different from the first control session is created, wherein the second control session is configured to control the controlled session and the controlled bearer, respectively;
providing, if the second control session is created, a control message for the controlled session and the controlled bearer, respectively, via the second control session.

20. The method according to claim 19, further comprising:
creating the second control session in response to the received request to initiate the second control session;
monitoring if the first control session is terminated;
inhibiting the creating of the second control session if the first control session is not terminated.

21. (canceled)

22. (canceled)

23. The method according to claim 19, wherein each of the first control session and the second control session is configured to provide quota for the controlled session and the controlled bearer, respectively; and the method further comprises:
deducting accumulated used quota from quota stored for the controlled session and the controlled bearer, respectively, wherein information on the accumulated used quota is received via the second control session.

24. (canceled)

25. The method according to claim 14, wherein the controlled session and the controlled bearer, respectively, provides an online charged service, and the online charging is controlled by each of the first control session and the second control session.

26. The method according to claim 14, wherein the controlled session is a connectivity access network session, and the controlled bearer is a connectivity access network bearer, respectively.

27. A computer program product embodied on a non-transitory computer-readable medium, said product comprising a set of instructions which, when executed on an apparatus, is configured to cause the apparatus to carry out the method according to claim 14.

28. (canceled)
